(19) United States
(12) Patent Application Publication
(10) Pub. No.: US 2010/0322183 A1
(43) Pub. Date: Dec. 23, 2010

(54) WIRELESS COMMUNICATION SYSTEM, TERMINAL DEVICE, AND WIRELESS COMMUNICATION METHOD IN WIRELESS COMMUNICATION SYSTEM

(75) Inventor: Takanori IWAMATSU, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/790,114

(22) Filed: May 28, 2010

(30) Foreign Application Priority Data
Jun. 18, 2009 (JP) 2009-144823

(51) Int. Cl. H04W 72/04

(52) U.S. Cl. 370/330

(57) ABSTRACT

A wireless communication system including: a first terminal device; and a second terminal device, wherein wireless communication is performed between the first and second terminal devices, the first and second terminal devices each include a processing unit performs wireless communication with the second and first terminal device respectively, using a wireless resource allocated within a first or second zone in accordance with a distance between the first and second terminal devices, and a wireless frame including a frequency domain and a time domain is divided into at least the first and second zones in the frequency domain or the time domain.

### CROSS-REFERENCE TO RELATED APPLICATIONS

This application is based upon and claims the benefit of priority from the prior Japanese Patent Application No. 2009-144823, filed on Jun. 18, 2009, the entire contents of which are incorporated herein by reference.

### FIELD

The embodiment discussed herein is related to a wireless communication system, a terminal device, and a wireless communication method in a wireless communication system.

### BACKGROUND

As an instance of conventional technologies relating to a wireless communication system, the wireless communication system is disclosed that includes a base station which, for instance, receives a duplexing mode determination factor from a wireless terminal during call setting; sets a backward mode to a time division duplexing mode or to a frequency division duplexing mode, on the basis of the received mode determination factor; and sets a time division duplexing mode for a backward channel and forward transmission for the set mode, to carry out thereby communication with the wireless terminal (for instance, Japanese Laid-open Patent Publication No. 2004-236322).

A mobile communication apparatus or the like also is disclosed wherein a communication channel recognition unit recognizes a infrastructure communication channel that does not disturb infrastructure communication within a wireless area of a base station, and a changeover switch 1-3 that switches the infrastructure communication channel so that the latter is diverted for adhoc communication by a communication channel diversion control unit (for instance, Japanese Laid-open Patent Publication No. 2008-17317).

In the wireless communication system set forth in Japanese Laid-open Patent Publication No. 2004-236322, however, the position of each base station is fixed, and hence the position of each communication area is likewise fixed. Japanese Laid-open Patent Publication No. 2008-17317, meanwhile does not disclose the feature of dividing resources for inter-terminal communication into short distance and long distance.

In inter-terminal communication, the communication areas are not fixed but changeable. Therefore, there may arise a situation in which the communication area uses the same frequency band as that of an adjacent communication area. This results in interference between the terminal devices in the different communication areas, whereupon the transmission power of the interfered terminal device may increase.

### SUMMARY

According to an aspect of the invention, a wireless communication system including: a first terminal device; and a second terminal device, wherein wireless communication is performed between the first and second terminal devices, the first and second terminal devices each include a processing unit performs wireless communication with the second and first terminal device respectively, using a wireless resource allocated within a first or second zone in accordance with a distance between the first and second terminal devices, and a wireless frame including a frequency domain and a time domain is divided into at least the first and second zones in the frequency domain or the time domain.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a wireless communication system;

FIG. 2 is a diagram illustrating a configuration example of a terminal device;

FIG. 3 is a diagram illustrating an example of zone allocation;

FIG. 4 is a diagram illustrating a zone allocation example and a configuration example of a wireless communication system;

FIG. 5 is a flowchart illustrating an operation example;

FIG. 6 is a diagram illustrating a configuration example of a terminal device;

FIG. 7 is a flowchart illustrating an operation example;

FIG. 8 is a diagram illustrating an example of zone allocation;

FIG. 9 is a diagram illustrating a zone allocation example and a configuration example of a wireless communication system;

FIG. 10 is a diagram illustrating a zone allocation example and a configuration example of a wireless communication system;

FIG. 11 is a diagram illustrating a zone allocation example and a configuration example of a wireless communication system;

FIG. 12 is a diagram illustrating a zone allocation example and a configuration example of a wireless communication system; and

FIG. 13 is a diagram illustrating a zone allocation example and a configuration example of a wireless communication system.

### DESCRIPTION OF EMBODIMENTS

Embodiments for carrying out the present invention are explained below.

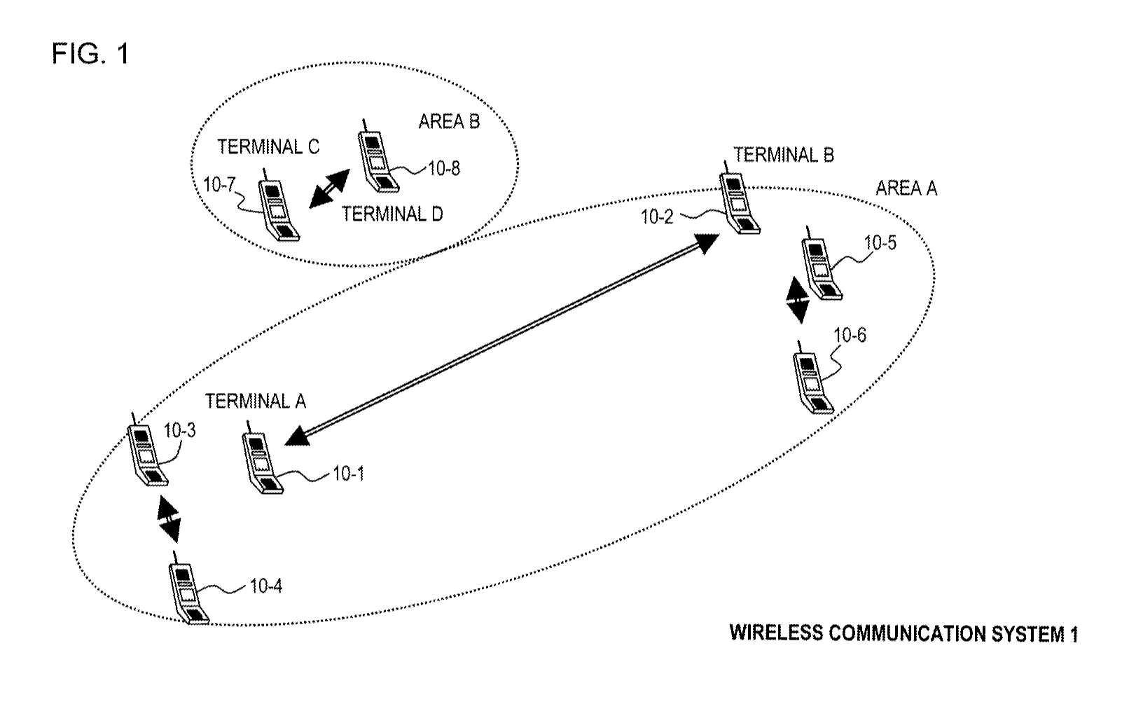

FIG. 1 is a diagram illustrating a configuration example of a wireless communication system 1. The wireless communication system 1 includes a plurality of terminal devices (hereafter, terminals) 10-1 to 10-8. Each the terminal 10-1 to 10-8 can perform wireless communication with other terminals 10-1 to 10-8 in a communication area. In the example illustrated in FIG. 1, the terminals 10-1 to 10-6 can perform wireless communication with each other within an area A, and the terminals 10-7 to 10-8 can perform wireless communication with each other within an area B. For instance, a parent terminal is disposed in each area. In area A, for instance, the terminal 10-5 is the parent terminal, while in area B the terminal 10-8 is the parent terminal. Each area denotes for instance an area within which respective parent terminals 10-5, 10-8 can communicate. The terminals 10-1 to 10-8 can communicate wirelessly with each other (hereafter, “inter-terminal communication”), without any intervening base station.

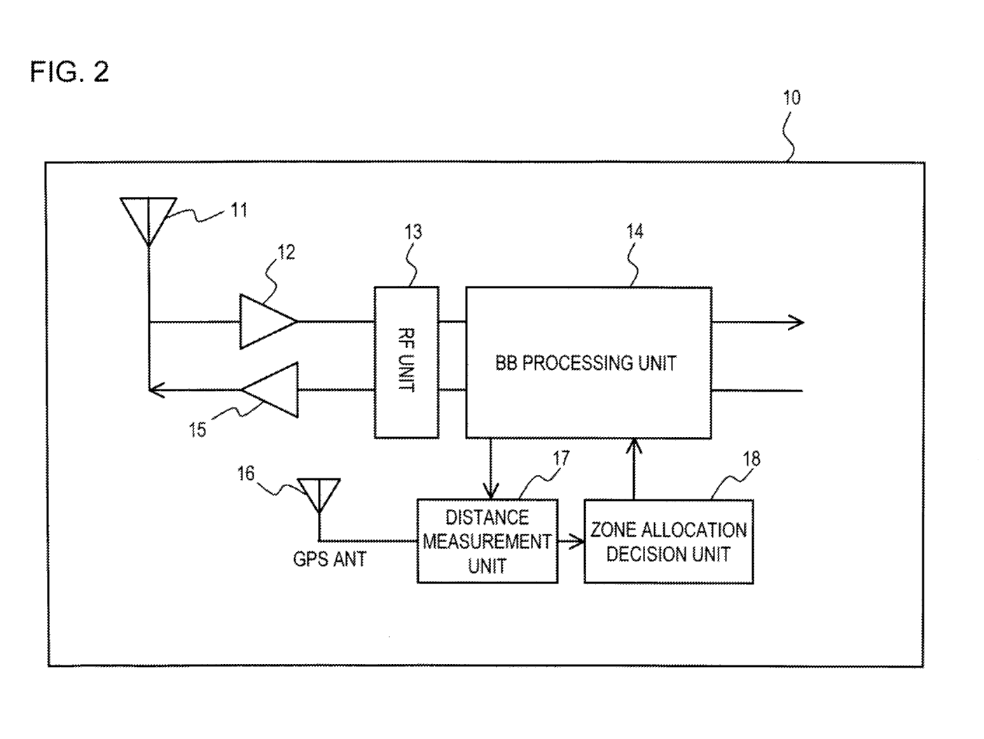

FIG. 2 is a diagram illustrating a configuration example of the terminal 10. The terminal 10 includes an antenna 11, a reception amplifier 12, an RF unit 13, a baseband (BB) processing unit 14, a GPS (Global Positioning System) antenna 16, a distance measurement unit 17, and a zone allocation decision unit 18.

The antenna 11 transmits wireless signal to other terminals, and receives wireless signal from other terminals.

The reception amplifier 12 amplifies the wireless signal received by the antenna 11.

The RF unit 13 controls the reception power or the like of the wireless signal outputted by the reception amplifier 12, and outputs the controlled reception power as a reception signal to the baseband processing unit 14. The RF unit 13 controls the transmission power or the like of transmission signal outputted by the baseband processing unit 14, and outputs the controlled transmission power as the wireless signal to a transmission amplifier 15.

The baseband processing unit 14 demodulates and decodes and so on the reception signal outputted by the RF unit 13 on the basis of a control signal or the like, and outputs reception data. The baseband processing unit 14 encodes and modulates inputted transmission data on the basis of the control signal or the like, and outputs the transmission signal. When the reception signal includes position information, the baseband processing unit 14 outputs the position information to the distance measurement unit 17.

The transmission amplifier 15 amplifies the wireless signal outputted by the RF unit 13, and outputs the resulting signal to the antenna 11.

The GPS antenna 16 receives a signal transmitted from a satellite or the like, and outputs the signal to the distance measurement unit 17.

The distance measurement unit 17 measures the position of the terminal 10 on the basis of the reception signal outputted by the GPS antenna 16. The distance measurement unit 17 determines whether the distance between two terminals that perform inter-terminal communication is a “long distance” or a “short distance”, on the basis of the position information outputted by the baseband processing unit 14 and the reception signal from the GPS antenna 16 and so on, and outputs the determination result to the zone allocation decision unit 18. In distance determination, for instance, the distance between two terminals is calculated on the basis of position information of the two terminals, and the distance is determined to be a “long distance” if it is equal to or greater than a threshold value, or a “short distance” if not.

The zone allocation decision unit 18 determines which zone to allocate for a wireless resource on the basis of the determination results from the distance measurement unit 17, and allocates the wireless resource in the zone to two terminals that perform inter-terminal communication. The zone allocation decision unit 18 outputs the allocated resource information to the baseband processing unit 14. The zone allocation decision unit 18 can output the position information of the terminal 10 outputted by the distance measurement unit 17, to the baseband processing unit 14.

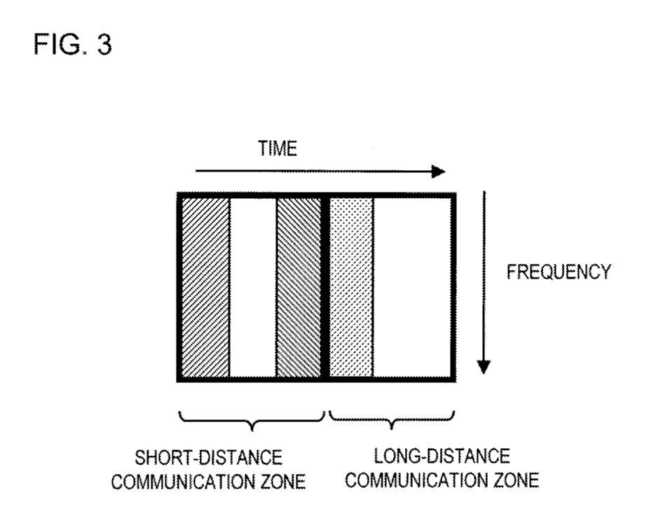

FIG. 3 is a diagram illustrating an example of zone allocation. The wireless frame (or a map information) has a wireless resource in a time domain and a frequency domain, for instance. In the example illustrated in FIG. 3, the wireless frame is divided into two zones in the time domain, namely a zone for short-distance communication and a zone for long-distance communication. The wireless frame used in inter-terminal communication is used at different timings, even if the same frequency band is allocated for short-distance communication and long-distance communication.

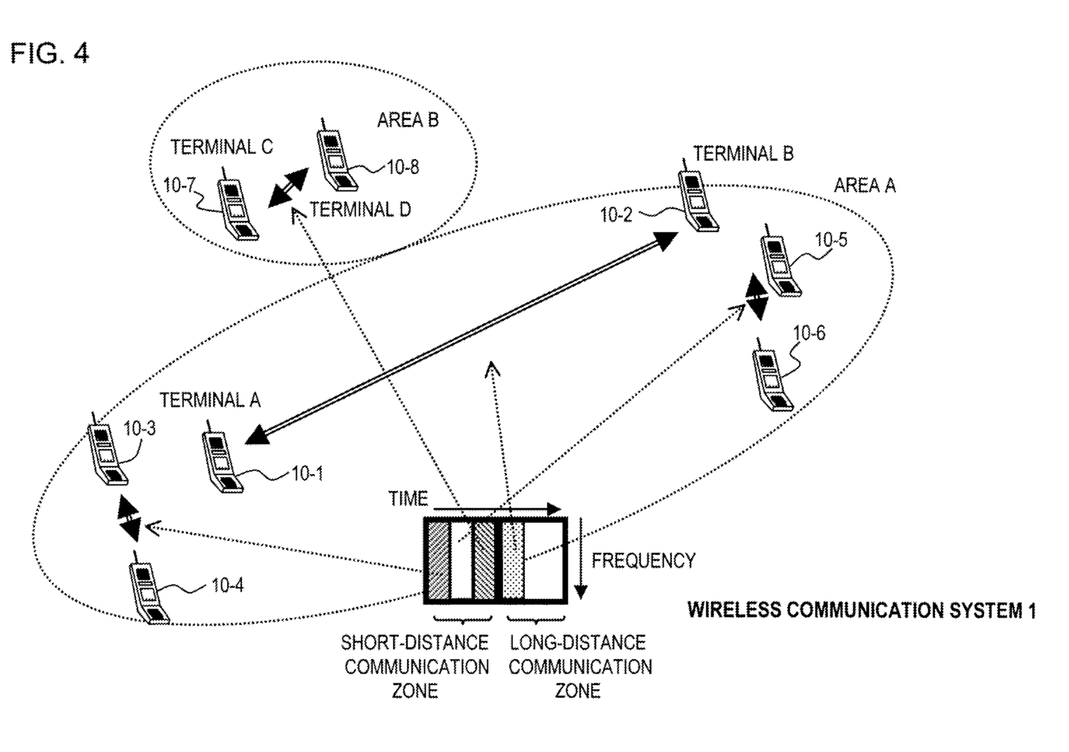

FIG. 4 is a diagram illustrating an example of allocation in the wireless communication system 1. Different respective wireless resources in the zone for short-distance communication in the wireless frame are allocated between the terminals 10-3, 10-4 and between the terminals 10-5, 10-6 in the communication area A, and between the terminals 10-7, 10-8, in the communication area B. The wireless resource in the zone for long-distance communication is allocated between the terminals 10-1, 10-2.

The above-described zone allocation is performed, for instance, by the parent terminal. In the example of FIG. 4, zone allocation is performed by the parent terminal 10-5 during inter-terminal communication between the terminals 10-1, 10-2. When either of the two terminals 10-1, 10-2 that perform inter-terminal communication is the parent terminal, zone allocation is performed by the parent terminal, as explained in detail further on. The terminal 10 of the parent terminal is for instance decided beforehand.

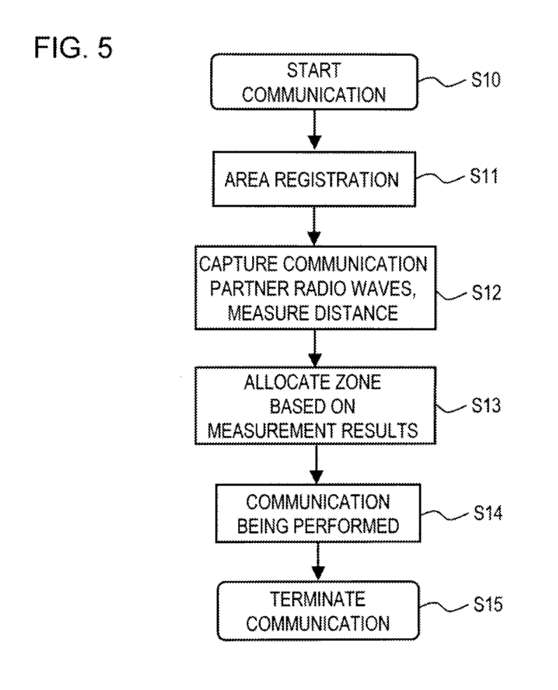

The operation of the system is explained next. FIG. 5 is a flowchart illustrating an operation example of the terminal 10. The terminal 10 stats communication (S10), and performs an area registration process (S11). The terminal 10, for instance, performs the area registration process for the parent terminal. During inter-terminal communication between the terminals 10-1, 10-2 in the example of FIG. 4, each the terminal 10-1, 10-2 performs the area registration process for the parent terminal 10-5. When the terminal 10-2 is the parent terminal, the terminal 10-1 performs the area registration process for the parent terminal 10-2.

For instance, the parent terminal 10-5 transmits periodically report information, the terminals 10-1, 10-2 receives the report information transmitted from the parent terminal 10-5. The notification information includes information that identifies the parent terminal 10-5. The terminals 10-1, 10-2 transmits an area registration request to the parent terminal 10-5 on the basis of the report information. The parent terminal 10-5 transmits an area registration permission notification, for the area registration request, to the terminals 10-1, 10-2. The area registration request is transmitted, for instance, by way of a common (control) channel.

For instance, the baseband processing unit 14 of the parent terminal 10-5 generates the report information periodically, and transmits the latter by way of the RF unit 13 and so forth. Upon reception of the area registration request, the baseband processing unit 14 of the parent terminal 10-5 outputs the area registration permission notification. Upon reception of the notification information via for instance the RF unit 13, the baseband processing unit 14 of the terminals 10-1, 10-2 generates the area registration request, and transmits the latter to the parent terminal 10-5. The parent terminal 10-5 may not perform the area registration process.

Next, the terminal 10 captures radio wave of a communication partner, and measures the distance thereto (S12). For instance, the two terminals 10-1, 10-2 performing inter-terminal communication transmits a communication start request to each other, and capture thereupon radio wave of the communication partner. The terminals 10-1, 10-2 measure the position of each own terminal.

The baseband processing unit 14 of each the terminal 10-1, 10-2 generates the communication start request, and transmits the request to the communication partner by way for instance of the RF unit 13. Upon reception of the communication start request via for instance the RF unit 13, the baseband processing unit 14 of each the terminal 10-1, 10-2 issues a distance measurement instruction to the distance measurement unit 17. The distance measurement unit 17 of each the terminal 10-1, 10-2 measures the position of the own terminal, and measured position information is transmitted to the parent terminal 10-5 via for instance the baseband processing unit 14. The distance measurement unit 17 of the parent terminal 10-5 receives the two position informations via for instance the baseband processing unit 14, and measures the “short distance” or the “long distance”. For example, when the terminal 10-2 is the parent terminal, the distance measurement unit 17 of the parent terminal 10-2 measures distance on the basis of the position information of the own terminal 10-2, from the GPS antenna 16, and on the basis of position information received from the terminal 10-1 via the baseband processing unit 14 or the like.

The terminal 10 performs next zone allocation on the basis of the measurement results (S13). For instance, the zone allocation decision unit 18 of the parent terminal 10-5 allocates the wireless resource in each zone on the basis of the determination result from the distance measurement unit 17. The allocated resource information (wireless frame information, or map information) is transmitted, for instance, to the terminals 10-1, 10-2 performing inter-terminal communication, via the baseband processing unit 14 or the like. When the terminal 10-2 is the parent terminal, the baseband processing unit 14 of the terminal 10-2 holds the resource information, and transmits the resource information to the terminal 10-1, via for instance the RF unit 13. As described above, the two terminals 10-1, 10-2 performing inter-terminal communication share the resource information.

The terminal 10 performs next inter-terminal communication on the basis of the resource information (S14). For instance, the respective baseband processing unit 14 of each the terminal 10-1, 10-2 holds the resource information, and transmits data or the like using frequency and time in accordance with the information.

The series of processes is ends (S15).

In the example of FIG. 4, inter-terminal communication is performed between the terminals 10-1, 10-2 using the wireless resource for long-distance communication, while inter-terminal communication is performed between the terminals 10-3, 10-4 using the wireless resource for short-distance communication. Interference can be avoided as a result, since dissimilar wireless resources are used between the terminals 10-1, 10-2 and between the terminals 10-3, 10-4. Likewise, dissimilar wireless resources are used between the terminals 10-1, 10-2 and between the terminals 10-6, 10-7 in the different wireless area, so that interference can be avoided as a result.

In the wireless communication system 1, thus, the wireless frame is divided between, and allocated to, two zones, namely for short distance and for long distance. This allows avoiding interference and preventing power increases in the terminals 10.

In the wireless communication system 1, wireless resources are allocated on the basis of the wireless frame that is divided beforehand into two zones. As a result, this allows exploiting more effectively the wireless resource, as compared with allocation of individual resource on the basis of the wireless frame for every inter-terminal communication.

When the same zone (for short-distance communication or for long-distance communication) is used in the different area in the example of FIG. 4, different wireless resource is preferably used for each area within the respective zone. Accordingly, there may be determined beforehand wireless resource that can be allocated within each zone, for the parent terminal of each area.

In the example explained above, the resource information transmitted to the terminal 10, as well as the measured position information, area registration requests and so forth are transmitted using for instance the common (control) channel (or using control signal). In FIG. 3, for instance, all regions are resource regions using the common channel

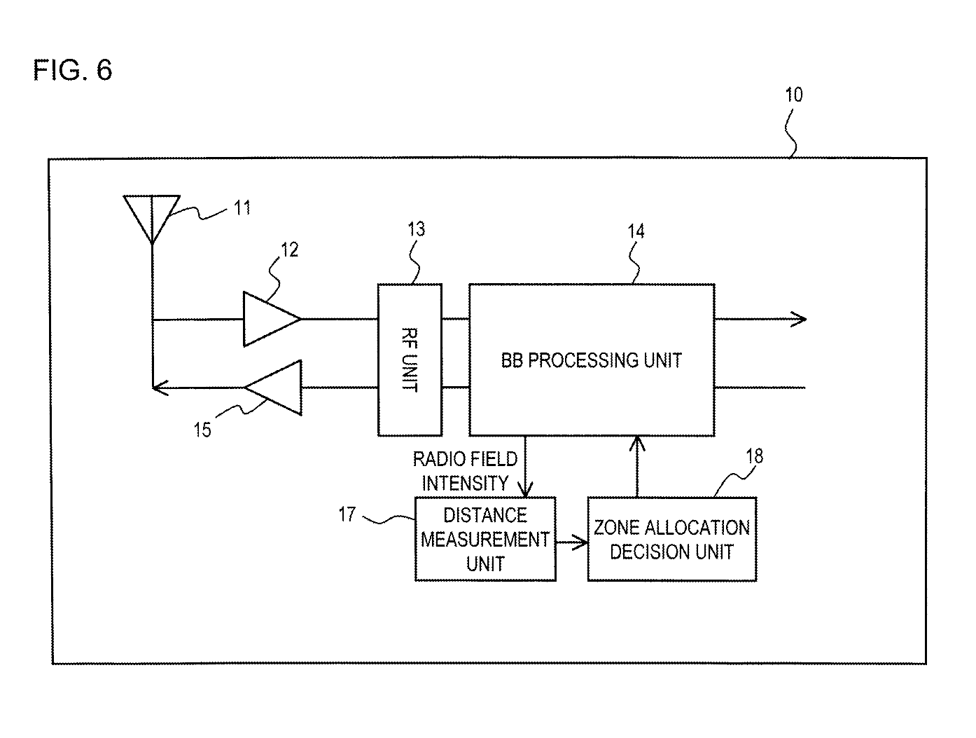

Another embodiment is explained next. FIG. 6 is a diagram illustrating another configuration example of the terminals 10. For instance, when the terminals 10-1, 10-2, from among the terminals 10, perform inter-terminal communication, the baseband processing units 14 of the terminals 10-1, 10-2 measure respective signal strength on the basis of a reception signal (for instance, a communication request signal, a pilot signal or the like) of the communication partner. The measured signal strength is transmitted to the parent terminal 10-5 via for instance the RF unit 13. The baseband processing unit 14 of the parent terminal 10-5 outputs the signal strength, transmitted by the respective terminals 10-1, 10-2, to the distance measurement unit 17. The distance measurement unit 17, for instance, determines “short distance” if the received signal strength is equal to or greater than the threshold value and determines “long distance” if not, and outputs the determination result. The zone allocation decision unit 18 performs for instance zone allocation on the basis of the determination result.

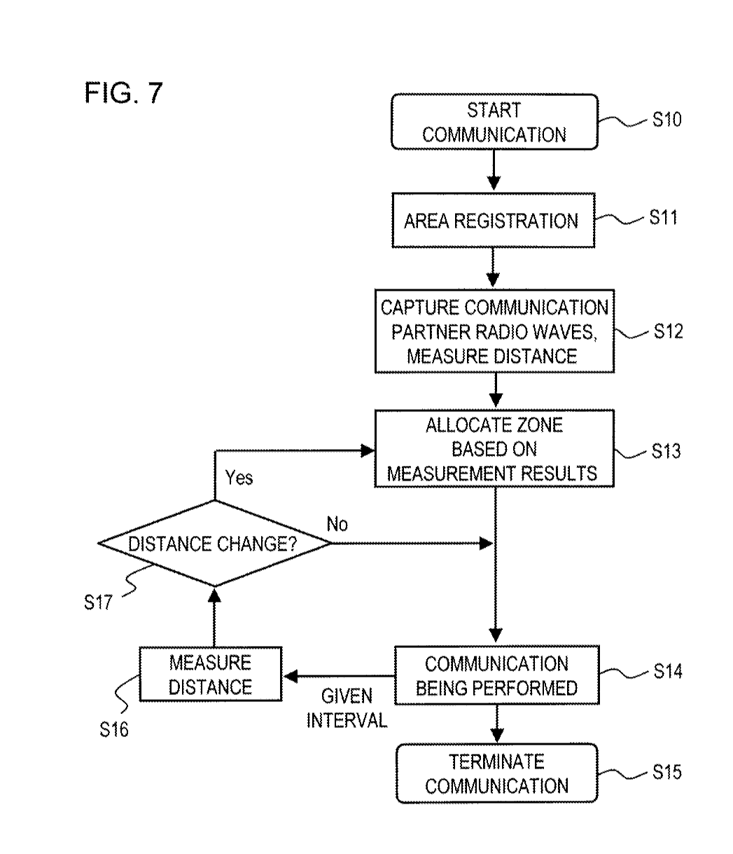

FIG. 7 is a flowchart illustrating another operation example. In the example illustrated in FIG. 7, the distance between the terminals is measured, for each given period, during inter-terminal communication (S16). If there is a change (Yes in S17), zone allocation is performed again (S13). In the process of S16 there is measured, by GPS, the position of the terminals 10, in the same way as in S12. The measured position information is transmitted to the parent terminal, and the parent terminal measures the distance on the basis of the modified position information. When the distance does not change (No in S17), wireless communication continues without zone re-allocation (S14).

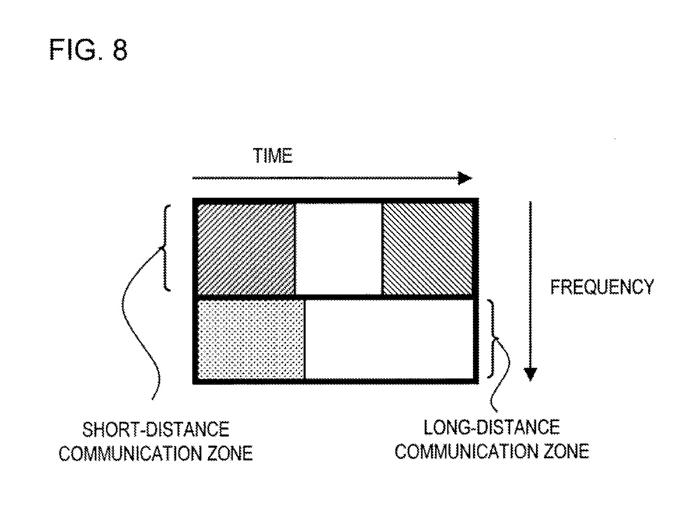

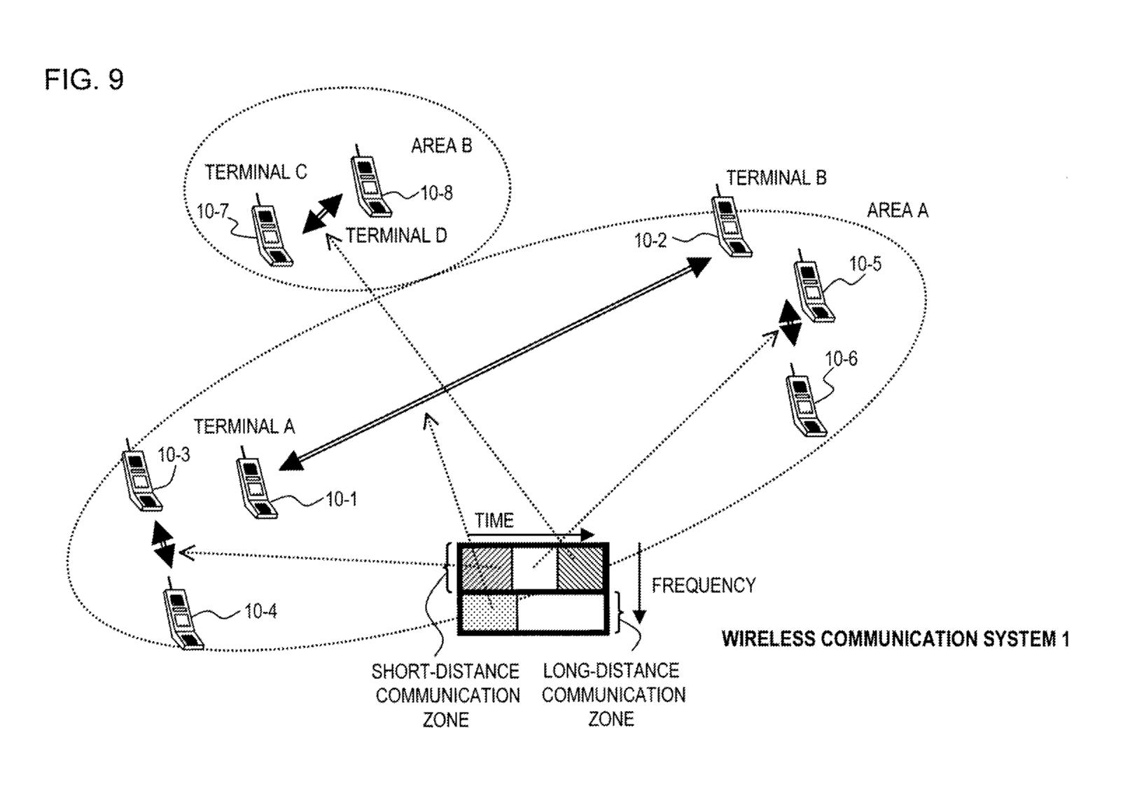

FIG. 8 to FIG. 11 illustrate other examples of zone allocation. FIG. 8 illustrates an example in which the wireless frame is divided, in the frequency domain, into two zones, for long distance and for short distance. FIG. 9 is a diagram illustrating an example of the wireless communication system 1 using such zone allocation. As illustrated in the figure, the “zone for short-distance communication” is allocated between the terminals 10-3, 10-4, between the terminals 10-5, 10-6 and between the terminals 10-7, 10-8. The “zone for long-distance communication” is allocated between the terminals 10-1, 10-2. Resource of dissimilar frequency domain is allocated for instance between the terminals 10-1, 10-2 and between the terminals 10-7, 10-8. This allows preventing interference between the two communications, and preventing power increase in the terminals 10. In this case as well, there may be decided beforehand dissimilar allocation regions between the parent terminals, in such a manner that dissimilar resource is allocated in respective areas within each zone. A comparison between allocation through division into different zones in the frequency direction (for instance, FIG. 8) and allocation through division into different zones in the time direction (for instance, FIG. 3) shows that there are more resources in the time domain, as a result of which instantaneous transmission power drops can be reduced.

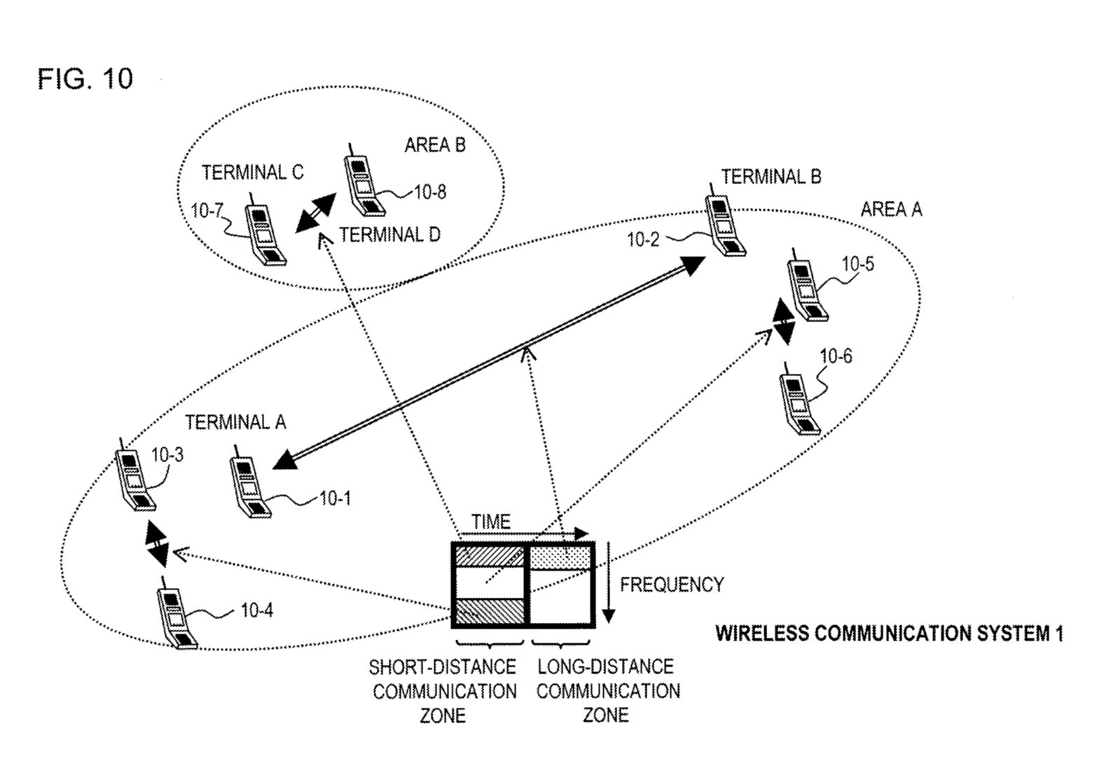

FIG. 10 is a diagram illustrating another zone allocation example. In the example of FIG. 10, the wireless resource is divided into two zones in the time domain, while each zone is divided into a plurality of resources in the frequency domain. In the example of FIG. 10, the divided respective resource is allocated to inter-terminal communication. In this case, dissimilar time domain resource is used between the terminals 10-1, 10-2 and between the terminals 10-7, 10-8. This allows preventing interference between two inter-terminal communications, and preventing power increase in the terminals 10-1 and so forth. As compared with an instance of division into different zones in the time direction (for instance, FIG. 3), in the present example there are more resource in the time domain, as a result of which instantaneous transmission power drops can be reduced.

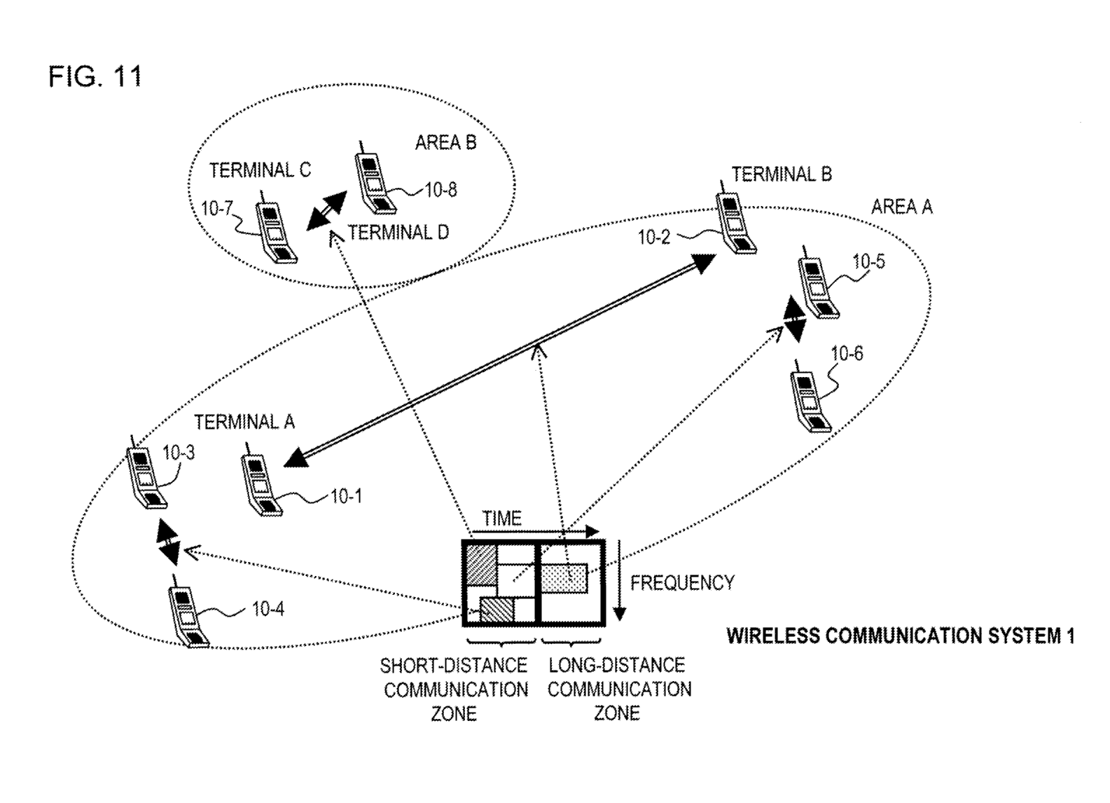

FIG. 11 is a diagram illustrating another zone allocation example. In the example of FIG. 11, the wireless resource is divided into two zones in the time domain, and is divided into both the frequency domain and the time domain within each zone. In the example of FIG. 11 as well, dissimilar time domain resource is used between the terminals 10-1, 10-2 and between the terminals 10-7, 10-8. This allows preventing interference between two communications, and allows preventing power increase in terminals 10-1 and so forth.

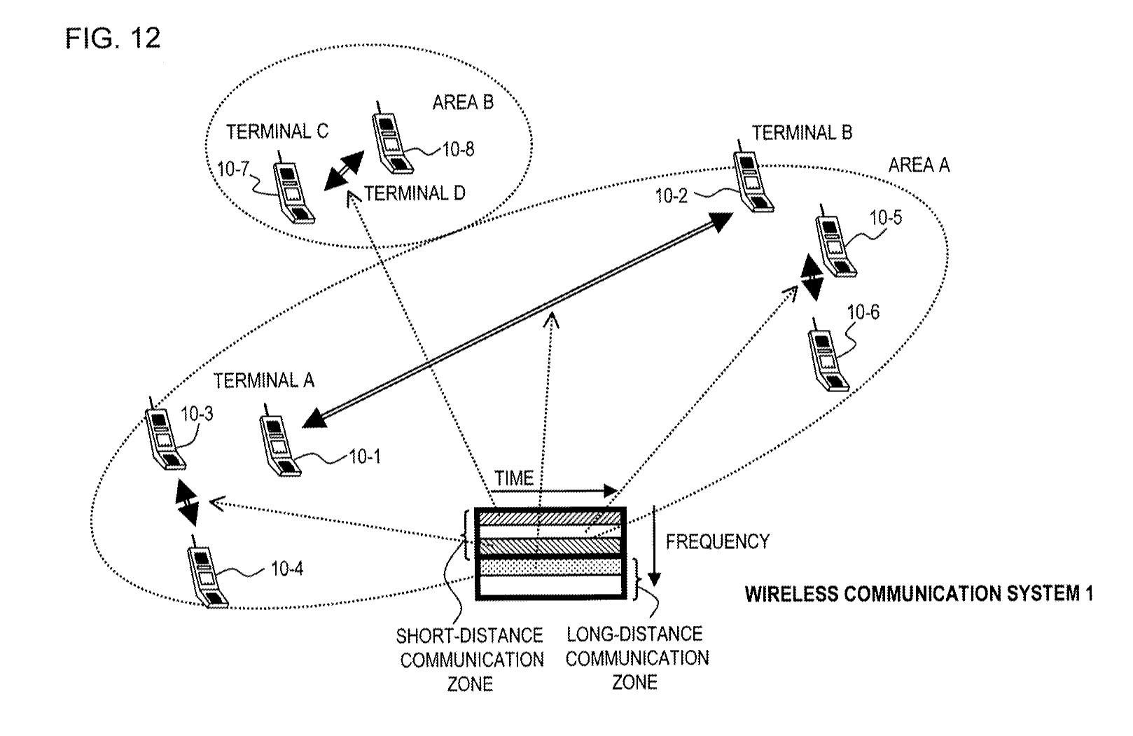

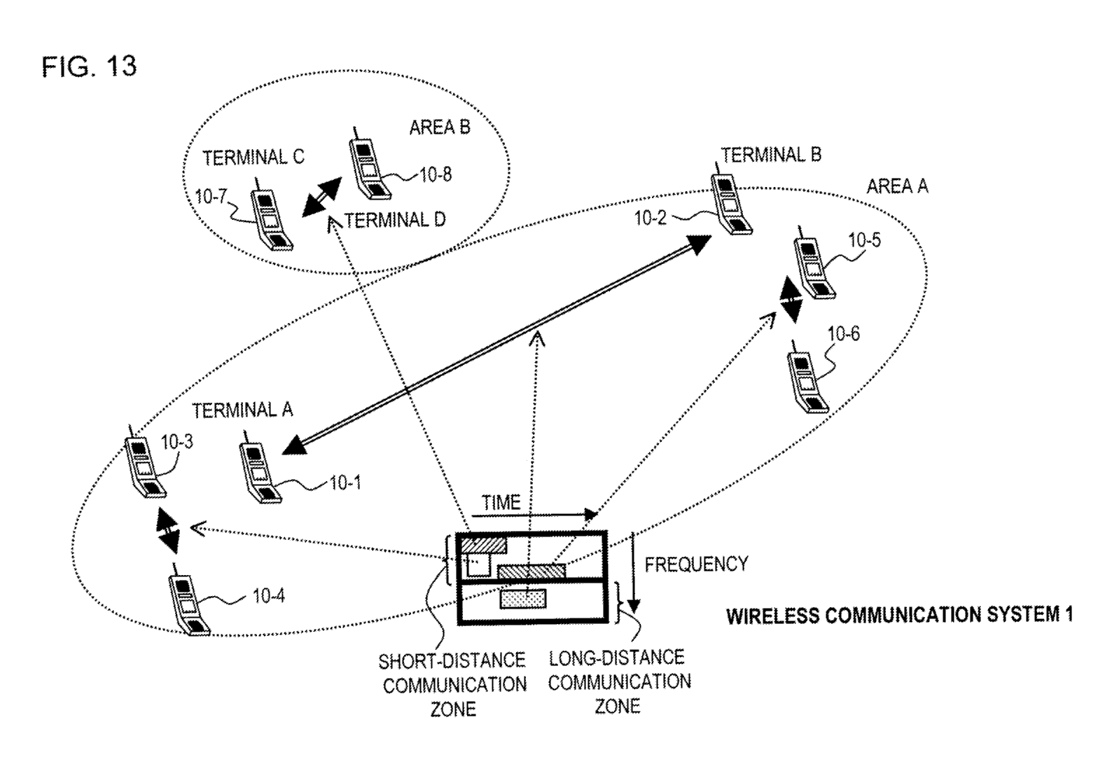

In the examples of FIG. 10 and FIG. 11, two zones are divided in the time domain. However, the example can also be realized with the two zones divided in the frequency domain (FIG. 8). For instance, the wireless frame may be divided into two zones in the frequency domain, and further divided in the time domain within each zone, to allocate thereby the divided wireless resource (for instance, FIG. 12). Also, the wireless frame may be divided into two zones in the frequency domain, and may be further divided in the time domain and frequency domain within each zone, to allocate thereby the divided wireless resource (for instance, FIG. 13).

In the examples explained above, the wireless frame is divided into two zones “for short-distance communication” and “for long-distance communication”, but there may be added for instance “for medium-distance communication”, so that the wireless frame is divided into three regions. In this case, the distance measurement unit 17 of the parent terminal can determine for instance “long distance”, “short distance” or “medium distance”, whereupon the zone allocation decision unit 18 allocates the resource on the basis of the determination result. The wireless resource may be divided into four or more regions.

In the example explained above, the parent terminal measures the distance between the terminals, determines “long distance” or “short distance”, and performs then resource allocation. The above determination and so forth, however, may be performed by the base station device or the like, instead of by the parent terminal. The base station device may includes, for instance, the zone allocation decision unit 18 and the distance measurement unit 17 that performs distance determination, wherein the terminals 10 transmits position information to the base station device and the zone allocation decision unit 18 transmits the resource information to the terminals 10. The area registration process (S11) may also be performed by the base station device.

The present invention succeeds in providing the wireless communication system, the terminal device, and the wireless communication system that allow preventing power increase in the terminal device.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A wireless communication system comprising:
a first terminal device; and
a second terminal device, wherein wireless communication is performed between the first and second terminal devices,
the first and second terminal devices each include a processing unit performs wireless communication with the second and first terminal device respectively, using a wireless resource allocated within a first or second zone in accordance with a distance between the first and second terminal devices, and
a wireless frame including a frequency domain and a time domain is divided into at least the first and second zones in the frequency domain or the time domain.

2. The wireless communication system according to claim 1, wherein the wireless resource further divided in the time domain or the frequency domain is allocated within the first or second zone to the processing unit, if the wireless frame is divided into the first and second zones in the time domain

3. The wireless communication system according to claim 1, wherein the wireless resource further divided in the time domain and the frequency domain is allocated within the first or second zone to the processing unit, if the wireless frame is divided into the first and second zones in the time domain.

4. The wireless communication system according to claim 1, wherein the wireless resource further divided in the time domain or the frequency domain is allocated within the first or second zone to the processing unit, if the wireless frame is divided into the first and second zones in the frequency domain.

5. The wireless communication system according to claim 1, wherein the wireless resource further divided in the time domain and the frequency domain is allocated within the first or second zone to the processing unit, if the wireless frame is divided into the first and second zones in the frequency domain.

6. The wireless communication system according to claim 1, wherein the first terminal device includes a distance measurement unit which measures the distance between the first and second terminal devices, an allocating unit which allocates the wireless resource within the first or second zone in accordance with the measured distance, and a transmitting unit which transmits the allocated wireless resource to the second terminal device.

7. The wireless communication system according to claim 2, wherein
the second terminal device includes a second distance measurement unit which measures a position of the second terminal device, and a transmitting unit which transmits the position to the first terminal device, and
the first terminal device measures a position of the first terminal device, and measures the distance on the basis of the measured position of the first terminal device and the transmitted position of the second terminal device.

8. The wireless communication system according to claim 1, further comprising a third terminal device, wherein
the first and second terminal devices each include a first and second distance measurement unit which measure positions of the first and second terminal devices respectively; and a first and second transmitting unit which transmit the measured information to the third terminal device respectively, and
the third terminal device includes a third distance measurement unit which measures the distance between the first and second terminal devices on the basis of the transmitted positions of the first and second terminal devices, an allocating unit which allocates the wireless resource within the first or second zone in accordance with the measured distance, and a third transmitting unit which transmits the allocated wireless resource to the first and second terminal devices.

9. The wireless communication system according to claim 1, wherein the wireless resource within the first and second zones is allocated to each the processing units in accordance with a received signal strength of the first and second terminal devices in place of in accordance with the distance.

10. A terminal device for performing wireless communication with another terminal device, the terminal device comprising:
a processing unit which performs wireless communication with the another terminal device using an wireless resource allocated within a first or second zone in accordance with a distance to the another device, wherein
a wireless frame including a frequency domain and a time domain is divided into at least the first and second zones.

11. A wireless communication method in a wireless communication system for performing wireless communication between first and second terminal devices, the method comprising:
being divided a wireless frame including a frequency domain and a time domain into at least a first and second zones in the frequency domain or the time domain; being allocated the wireless resource within the first or second zone in accordance with a distance between the first and second terminal devices to the first and second terminal devices; and
performing wireless communication with the second and first terminal devices respectively, using the allocated wireless resource.
